(19) United States
(12) Patent Application Publication
(10) Pub. No.: US 2011/0292788 A1
(43) Pub. Date: Dec. 1, 2011

(54) FRAME DATA COMMUNICATION

(76) Inventor: Masahiko TSUCHIYA, Tokyo (JP)

(21) Appl. No.: 13/114,720

(22) Filed: May 24, 2011

(30) Foreign Application Priority Data
May 25, 2010 (JP) 2010-119223

(51) Int. Cl. H04L 12/56; H04L 12/24

(52) U.S. Cl. 370/218; 370/392; 370/243

(57) ABSTRACT

A switch node stores reception connection information for identifying the connection of frame data that are received in association with transmission connection information for identifying the connection to which the frame data are to be transmitted, and upon receiving frame data, searches for the transmission connection information that was placed in association with the reception connection information of the frame data that were received and distributes and transmits the frame data to the connection of the transmission connection information that was found.

This application is based upon and claims the benefit of priority from Japanese Patent Application No. 2010-119223 filed on May 25, 2010, the content of which is incorporated by reference.

### BACKGROUND OF THE INVENTION

1. Technical Field

The present invention relates to a communication system that implements communication of frame data, and more particularly relates to a communication system that uses link aggregation to implement communication of frame data.

2. Background Art

In recent years, a communication technology has come into popular use that uses link aggregation to handle a plurality of physical communication links as one virtual link.

In a communication system that is made up from a plurality of switch nodes and that uses this link aggregation to implement communication of frame data, the link aggregation process is defined for each bridge communication apparatus, which is a switch node. When frame data are transmitted to a link aggregation communication port in this process, a transmission destination distribution process is effected based on the MAC DA (Media Access Control Destination Address), the SA (Source Address), or other fields (IP (Internet Protocol) addresses) in frame data.

In addition, technology has been disclosed for managing each of the communication bands of the physical communication channels and logical connections within communication channels that make up link aggregation and for achieving the optimum allocation of communication channels (for example, refer to Patent Literature 1).

### Citation List

### Patent Literature

### Patent Literature 1: JP-2006-115392-A

### SUMMARY OF INVENTION

### Technical Problem

Nevertheless, in the above-described technology, when frame data are transferred in several hops with link aggregation made up of a plurality of ports, a distribution process is carried out for each hop by referring to the MAC address or IP address in the frame data.

As a result, the problem arises regarding circuits or functions to carry out it is complicated because frame data that are received and in which processing must be carried out until frame data are realized that allow referencing of the MAC address or IP address (MAC frames or IP packets).

It is an object of the present invention to provide a communication system that solves the above-described problem, especially, to decrease a load to process by being simple process at a relay node of LAG.

### Solution to Problem

The communication system of the present invention is made up of a plurality of switch nodes that distribute and transmit received frame data to a desired destination and that uses link aggregation to carry out frame data communication among the plurality of switch nodes, wherein a relay node among the plurality of switch nodes comprises:

a link aggregation table that stores reception connection information for identifying connections of the received frame data in association with transmission connection information for identifying connections to which the frame data are to be transmitted; and

a simple distribution unit that, when the frame data are received, searches the link aggregation table for transmission connection information that is placed in association with the reception connection information of the frame data that was received and distributes and transmits the frame data to the connection of the transmission connection information that was found.

### Advantageous Effects of Invention

In the present invention as described hereinabove, frame data can be readily distributed and transmitted at each of a plurality of switch nodes.

The above and other objects, features, and advantages of the present invention will become apparent from the following description with reference to the accompanying drawings which illustrate an example of the present invention.

### BRIEF DESCRIPTION OF DRAWINGS

FIG. 1 shows an exemplary embodiment of the communication system of the present invention;

FIG. 2 shows details of the exemplary embodiment shown in FIG. 1;

FIG. 3 shows an example of the construction of frame data that are transmitted and received in the exemplary embodiment shown in FIG. 2;

FIG. 4 shows an example of the internal configuration of a switch node shown in FIG. 2;

FIG. 5 shows an example of the construction of the link aggregation table shown in FIG. 4;

FIG. 6 shows an example of the construction of the connection label table shown in FIG. 4;

FIG. 7 shows another example of the internal configuration of the switch node shown in FIG. 2;

FIG. 8 shows the state when a fault occurs in a communication channel in the exemplary embodiment shown in FIG. 2;

FIG. 9 shows an example in which the correspondence stored by the link aggregation table shown in FIG. 5 is rewritten;

FIG. 10 shows a form of the system in which fault information is reported by a switch node; and

FIG. 11 shows an actual example of the configuration of the communication system of the present invention.

### EXEMPLARY EMBODIMENTS

An exemplary embodiment of the present invention is next described with reference to the accompanying figures.

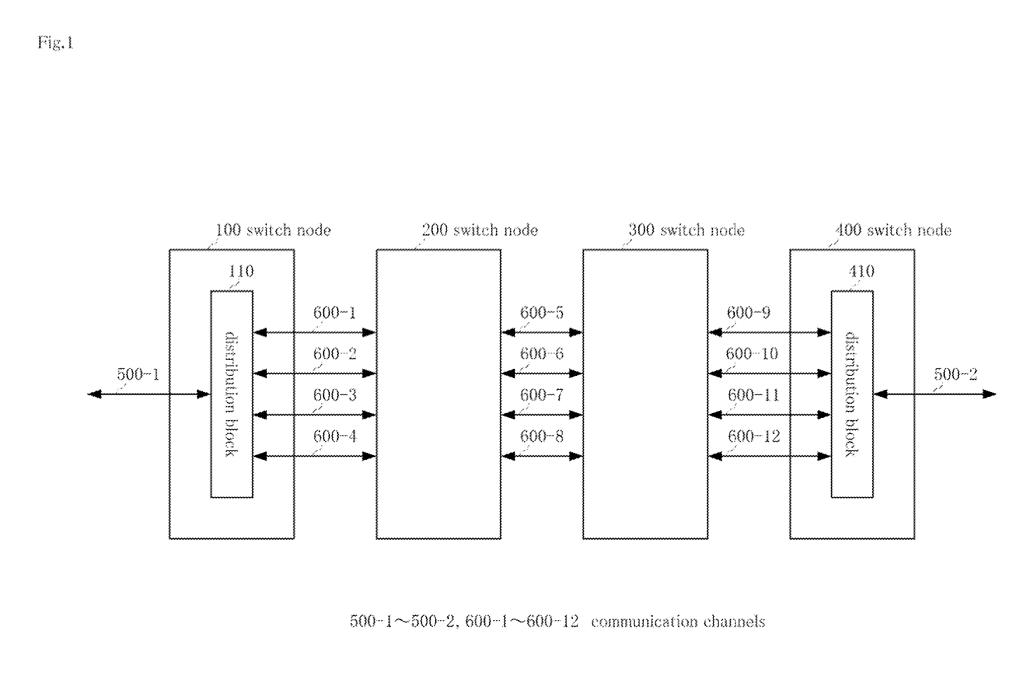

As shown in FIG. 1, this exemplary embodiment is of a configuration in which a plurality of switch nodes 100, 200, 300, and 400 that are communication apparatuses are connected in a series. A form is here presented by way of example in which communication apparatuses are connected in a case in which link aggregation functions are realized in a connection-oriented communication network. The communication system of the present exemplary embodiment uses link aggregation to implement frame data communication.

Switch node 100 is an existing edge communication node arranged at the edge of connected connections. Switch node 100 uses connection-oriented communication channels 600-1-600-4 to transmit to and receive from switch node 200 a communication stream of MAC frames that are frame data (communication frames) received from communication channel 500-1 that is a data communication channel (Ethernet port) or that are transmitted to communication channel 500-1.

Switch node 400 is an existing edge communication node that is arranged at the edge of connected connections. Switch node 400 uses connection-oriented communication channels 600-9-600-12 to transmit to and receive from switch node 300 a communication stream of MAC frames that are frame data received from communication channel 500-2 that is a data communication channel (Ethernet port) or that are transmitted to communication channel 500-2.

Switch node 200 is a relay communication node that carries out communication with switch node 100 by way of communication channels 600-1-600-4. In addition, switch node 200 carries out communication with switch node 300 by way of communication channels 600-5-600-8. Switch node 200 further distributes and transmits frame data that were received to desired destinations.

Switch node 300 is a relay communication node that carries out communication with switch node 200 by way of communication channels 600-5-600-8. In addition, switch node 300 carries out communication with switch node 400 by way of communication channels 600-9-600-12. Switch node 300 further distributes and transmits frame data that were received to desired destinations.

Communication channels 600-1-600-12 may be Ethernet media such as FASTETHERNET, gigabit Ethernet, and 10 G-bit Ethernet. Communication channels 600-1-600-12 may also be wavelength paths (for example, communication channels 600-1-600-12 are communication channels in which data are multiplexed and transferred on communication channels having mutually different communication wavelengths) that pass via WDM (Wavelength Division Multiplexing) apparatuses. Still further, communication channels 600-1-600-12 may also be connection paths of Ethernet OVER SONET (Synchronous Optical NETwork)/SDH (Synchronous Digital Hierarchy) standardized in ITU-T G. 7041 and G. 7042. Communication channels 600-1-600-12 may be connection paths of Ethernet OVER OTN (Optical Transport Network) in the process of standardization by ITU-T G. 709, or may be connection paths of PBB-TE (Provider Backbone Bridging-Traffic Engineering) in the process of standardization by IEEE 802.1 Qay or MPLS-TP (MultiProtocol Label Switching-Transport Profile) in the process of standardization by IETF and ITU-T. Communication channels 600-1-600-12 are shown as channels that include physical data communication channels and logical data communication channels.

Frame data that switch node 100 receives from communication channel 500-1 are distributed to communication channels 600-1-600-4 by distribution block 110 that is a link aggregation distribution function equipped in switch node 100.

More specifically, regarding frame data that are received from communication channel 500-1, switch node 100 implements a destination search function to determine transmission destination ports. Switch node 100 then, in distribution block 110, implements a “distribution process” of selecting one destination port among the member ports of a link aggregation group based on the MAC address or IP address of the frame data and transmits the frame data toward the destination port. Here, in the case of MPLS-TP or PBB-TE communication mode, switch node 100 adds to the original frame data a connection identifier that is connection information used for transferring in switch node 200 and succeeding switch nodes and then transmits the frame data. These processes are known link aggregation processes, and explanation regarding the actual internal configuration of switch node 100 is therefore here omitted.

In addition, frame data received by switch node 400 from communication channel 500-2 are distributed to communication channels 600-9-600-12 by distribution block 410 that performs the link aggregation distribution function that is equipped in switch node 400. The communication paths that actually perform communication are thus determined and communication is carried out.

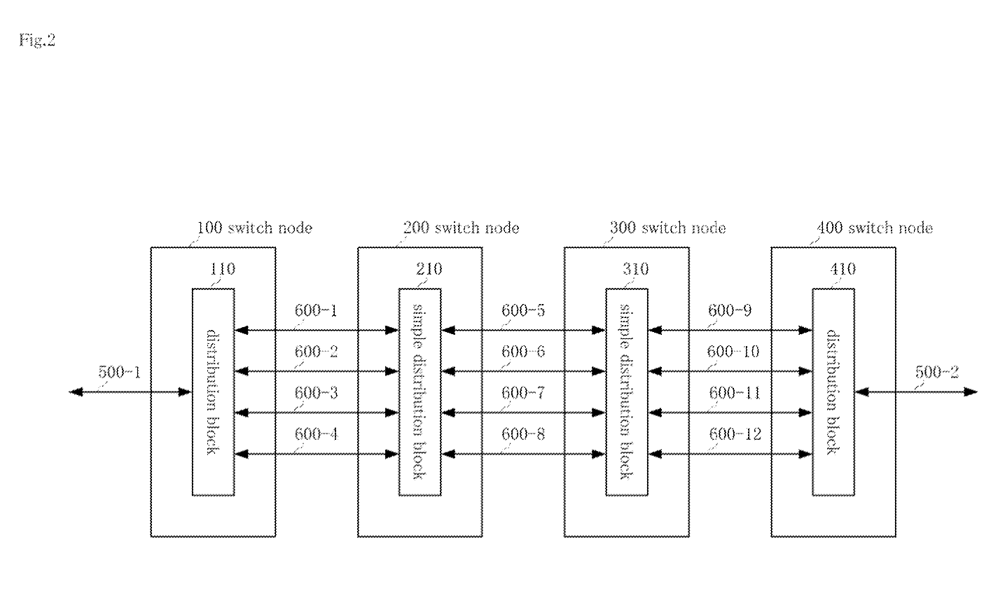

As shown in FIG. 2, simple distribution block 210 is provided in switch node 200. In addition, simple distribution block 310 is provided in switch node 300. In FIG. 2, a case is shown by way of example in which one simple distribution block is provided in each of switch nodes 200 and 300, but simple distribution blocks may be separately provided for each of the distribution of frame data that are transmitted from switch node 100 toward switch node 400 and the distribution of frame data that are transmitted from switch node 400 toward switch node 100.

In switch nodes that are provided at positions where switch node 200 and switch node 300, shown in FIG. 2 in a typical communication system, are arranged, link aggregation is implemented for each node. In other words, frame data that are transmitted over a communication channel between neighboring switch nodes and that undergo the link aggregation distribution process at the receiving switch node, are transferred to the switch node of the succeeding stage (next hop), and again undergo the link aggregation distribution process at the switch node of the next hop.

At this time, the destination physical link is determined by using a method such as HASHING to implement a “distribution process” of determining the transmission destination physical link of the frame data by using the transmission source MAC address information, destination MAC address information, the transmission source IP address, the destination IP address, and information of other fields that are contained in the frame data at each switch node.

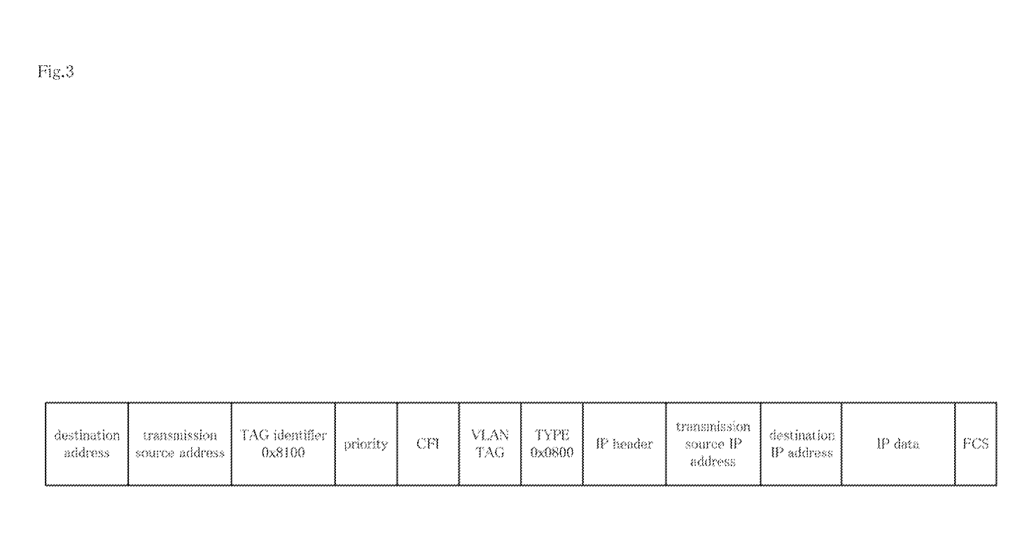

The frame data shown in FIG. 3 are made up of the destination address, the transmission source address, a TAG identifier, priority, CFI, VLAN TAG, TYPE, IP header, the transmission source IP address, destination IP address, IP data, and FCS. These fields are identical to the fields that make up typical frame data.

In the invention of the present application, the use of simple distribution blocks 210 and 310 shown in FIG. 2 simplifies the “distribution process” carried out in switch nodes 200 and 300.

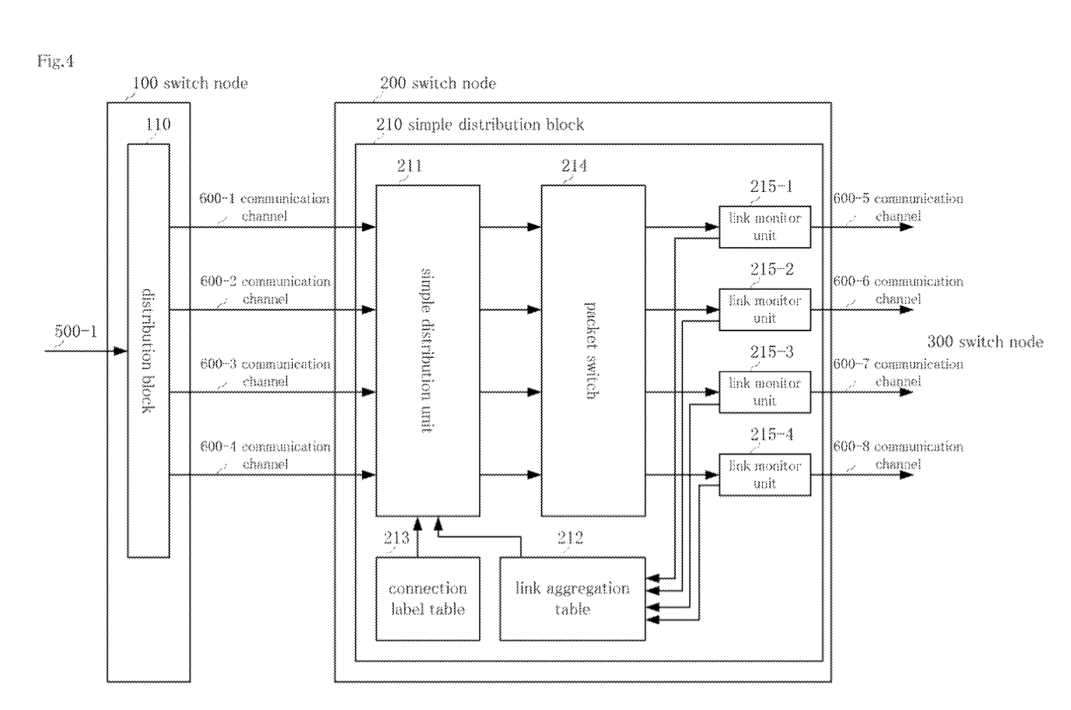

As shown in FIG. 4, simple distribution block 210 of switch node 200 shown in FIG. 2 is provided with simple distribution unit 211, link aggregation table 212, connection label table 213, packet switch 214, and link monitor units 215-1-215-4. The internal configuration of switch node 300 shown in FIG. 2 is also of the same configuration.

Link aggregation identification information for identifying link aggregation groups, reception connection information for identifying the connection of frame data that are received by switch node 200, and transmission connection information for identifying the connection frame data that are to be transmitted are stored in association with each other in link aggregation table 212.

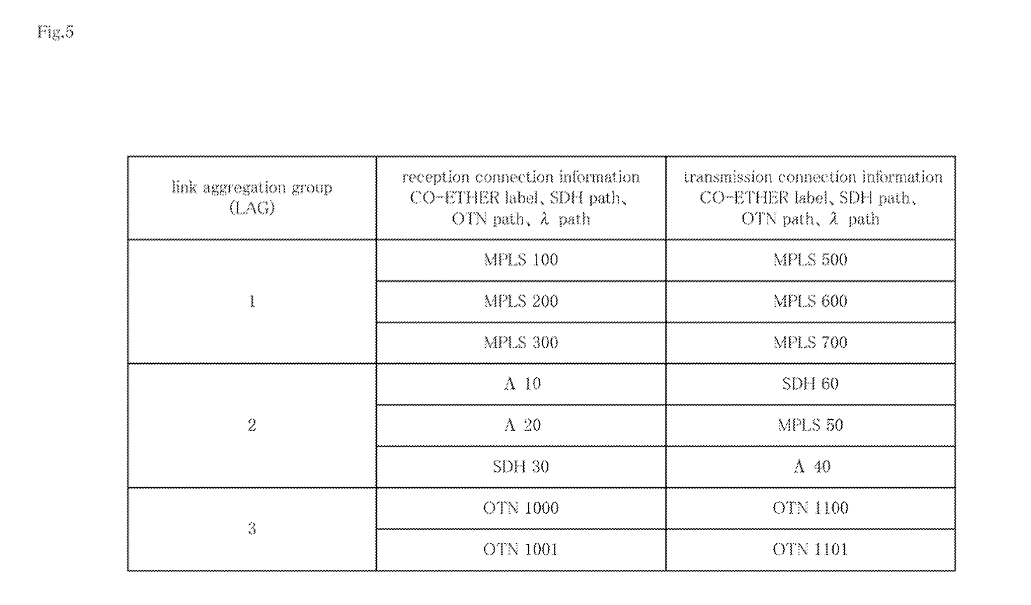

As shown in FIG. 5, the link aggregation group (LAG), which is link aggregation identification information, reception connection information, and transmission connection information are stored in association with each other in advance in link aggregation table 212 that is shown in FIG. 4.

Here, the connection information is information such as MPLS label ID or transmission path ID of physical layers that can identify connections such as VLAN or SDH connections, OTN connections, and λ connections and is information that is added to frame data that are received.

For example, link aggregation group “1,” reception connection information “MPLS100,” and transmission connection information “MPLS500” are stored in association with each other as shown in FIG. 5. By using this information, when the link aggregation group of frame data that are received by switch node 200 is “1,” and moreover, when the reception connection information is “MPLS100,” the frame data are distributed in simple distribution unit 211 to the connection for which the transmission connection information is “MPLS500.”

Alternatively, link aggregation group “1,” reception connection information “MPLS200,” and transmission connection information “MPLS600” are stored in association with each other. By using this information, when the link aggregation group of the frame data that are received by switch node 200 is “1,” and moreover, when the reception connection information is “MPLS200,” the frame data are distributed in simple distribution unit 211 to the connection for which the transmission connection information is “MPLS600.”

Alternatively, link aggregation group “1,” reception connection information “MPLS300,” and transmission connection information “MPLS700” are stored in association with each other. By using this information, frame data are distributed in simple distribution unit 211 to the connection for which the transmission connection information is “MPLS700” when the link aggregation group of the frame data that are received by switch node 200 is “1,” and moreover, when the reception connection information is “MPLS300.”

Alternatively, link aggregation group “2,” reception connection information “Λ10,” and transmission connection information “SDH60” are stored in association with each other. By using this information, when the link aggregation group of frame data that are received by switch node 200 is “2,” and moreover, when the reception connection information is “Λ10,” the frame data are distributed in simple distribution unit 211 to the connection for which the transmission connection information is “SDH60.”

Alternatively, link aggregation group “2,” reception connection information “Λ20,” and transmission connection information “MPLS50” are stored in association with each other. By using this information, when the link aggregation group of frame data that are received by switch node 200 is “2,” and moreover, when the reception connection information is “Λ20,” the frame data are distributed in simple distribution unit 211 to the connection for which the transmission connection information is “MPLS50.”

Alternatively, link aggregation group “2,” reception connection information “SDH30,” and transmission connection information “Λ40” are stored in association with each other. By using this information, when the link aggregation group of frame data that are received by switch node 200 is “2,” and moreover, when the reception connection information is “SDH30,” the frame data are distributed in simple distribution unit 211 to the connection for which the transmission connection information is “Λ40.”

Alternatively, link aggregation group “3,” reception connection information “OTN1000” and transmission connection information “OTN1100” are stored in association with each other. By using this information, when the link aggregation group of frame data that are received by switch node 200 is “3,” and moreover, when the reception connection information is “OTN1000,” the frame data are distributed in simple distribution unit 211 to the connection for which the transmission connection information is “OTN1100.”

Alternatively, link aggregation group “3,” reception connection information “OTN1001” and transmission connection information “OTN1101” are stored in association with each other. By using this information, when the link aggregation group of frame data that are received by switch node 200 is “3,” and moreover, when the reception connection information is “OTN1001,” the frame data are distributed in simple distribution unit 211 to the connection for which the transmission connection information is “OTN1101.”

When switch node 200 receives frame data, simple distribution unit 211 checks whether the received frame data pertain to link aggregation. When the frame data are verified to pertain to link aggregation, simple distribution unit 211 further searches link aggregation table 212 for transmission connection information that was placed in association with the link aggregation group identification information and reception connection information of the link aggregation group that is being used.

Simple distribution unit 211 distributes the frame data to the connection of the transmission connection information that was found in link aggregation table 212 and transmits the frame data to switch node 300 by way of packet switch 214. In FIG. 4, a case is shown by way of example in which simple distribution unit 211 is used in common by communication channels 600-1-600-4 (there is one simple distribution unit), but a simple distribution unit may be provided for each of communication channels 600-1-600-4.

Thus, when frame data (MAC frames in this case) that are distributed in distribution block 110 of switch node 100 and that are transmitted in by way of communication channels 600-1-600-4 are received in switch node 200, the frame data are distributed in simple distribution unit 211 based on information that is stored in link aggregation table 212 of simple distribution block 210 and are transmitted to switch node 300 of the next stage.

Alternatively, simple distribution unit 211 uses information that is stored in connection label table 213 in the distribution of the frame data. Essentially, upon the reception of frame data, simple distribution unit 211 searches connection label table 213 for the transmission port number and transmission connection information that have been placed in association with the reception connection information and reception port number of the reception port that received the frame data. Simple distribution unit 211 further distributes the frame data to the connection of the transmission connection information and the transmission port of the transmission port number that was searched and transmits the frame data to switch node 300 by way of packet switch 214.

Reception connection information, transmission connection information, the reception port number for identifying the reception port that received the frame data, and the transmission port number for identifying the transmission port that transmits the frame data are stored in association with each other in connection label table 213. A plurality of these reception ports and transmission ports are provided for switch node 200.

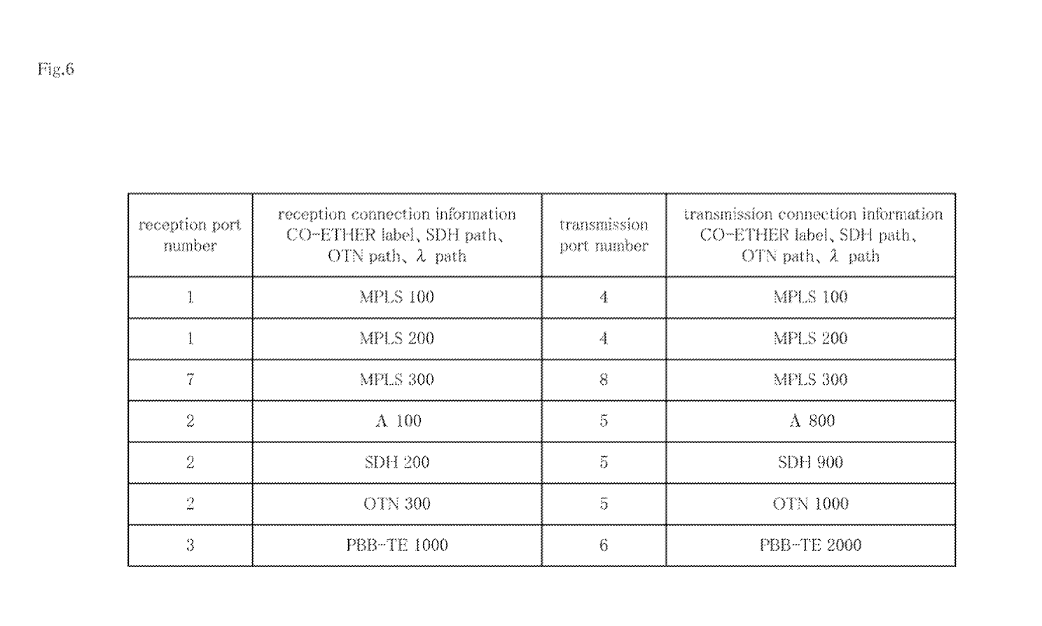

As shown in FIG. 6, reception port numbers, reception connection information, and transmission connection information are stored in association with each other in connection label table 213 shown in FIG. 4.

For example, reception port number “1,” reception connect information “MPLS100,” transmission port “4,” and transmission connection information “MPLS100” are stored in association with each other. By using this information, frame data that are received at a reception port for which the reception port number is “1” in switch node 200, and moreover, for which the reception connection information is “MPLS100”, are distributed in simple distribution unit 211 to the connection for which the transmission port number is “4” and for which the transmission connection information is “MPLS100.”

Alternatively, reception port number “1,” reception connection information “MPLS200,” transmission port “4,” and transmission connection information “MPLS200” are stored in association with each other. By using this information, frame data that are received at the reception port for which the reception port number is “1” in switch node 200, and moreover, for which the reception connection information is “MPLS200”, are distributed in simple distribution unit 211 to the connection for which the transmission port number is “4” and the transmission connection information is “MPLS200.”

Alternatively, reception port number “7,” reception connection information “MPLS300,” transmission port “8,” and transmission connection information “MPLS300” are stored in association with each other. By using this information, frame data that are received at the reception port for which the reception port number is “7” in switch node 200, and moreover, for which the reception connection information is “MPLS300”, are distributed in simple distribution unit 211 to the connection for which the transmission port number is “8” and the transmission connection information is “MPLS300.”

Alternatively, reception port number “2,” reception connection information “Λ100,” transmission port “5,” and transmission connection information “Λ800” are stored in association with each other. By using this information, frame data that are received at the reception port for which the reception port number is “2” in switch node 200, and moreover, for which the reception connection information is “Λ100”, are distributed in simple distribution unit 211 to the connection for which the transmission port number is “5” and the transmission connection information is “Λ800.”

Alternatively, reception port number “2,” reception connection information “SDH200,” transmission port “5,” and transmission connection information “SDH900” are stored in association with each other. By using this information, frame data that are received at the reception port for which the reception port number is “2” in switch node 200, and moreover, for which the reception connection information is “SDH200”, are distributed in simple distribution unit 211 to the connection for which the transmission port number is “5” and the transmission connection information is “SDH900.”

Alternatively, reception port number “2,” reception connection information “OTN300,” transmission port “5,” and transmission connection information “OTN1000” are stored in association with each other. By using this information, frame data that are received at the reception port for which the reception port number is “2” in switch node 200, and moreover, for which the reception connection information is “OTN300”, are distributed in simple distribution unit 211 to the connection for which the transmission port number is “5” and the transmission connection information is “OTN1000.”

Alternatively, reception port number “3,” reception connection information “PBB-TE1000,” transmission port “6,” and transmission connection information “PBB-TE2000” are stored in association with each other. By using this information, frame data that are received at the reception port for which the reception port number is “3” in switch node 200, and moreover, for which the reception connection information is “PBB-TE1000”, are distributed in simple distribution unit 211 to the connection for which the transmission port number is “6” and the transmission connection information is “PBB-TE2000.”

Packet switch 214 switches and supplies frame data that have been distributed in simple distribution unit 211 as output based on the transmission connection and transmission port.

As described hereinabove, associating reception connection information one-to-one with transmission connection information enables the elimination of the “distribution process” of extracting the fields identified as the MAC address or IP address in the frame data of reception traffic in order to determine the output port. The extraction of MAC address or IP address information from received frames necessitates the execution of: a process of once storing information relating to long bytes from the head of the received frames, a process of extracting specific header information from this information, and an arithmetic process of determining the distribution destination by means of, for example, HASHING the extracted header information. The present invention allows the omission of these processes and enables the adoption of a configuration that contributes to the simplification of processing.

In addition, each of link monitor units 215-1-215-4 monitors whether a fault has occurred in each of communication channels 600-5-600-8, respectively, that are the communication links. When a fault is detected in communication channels 600-5-600-8, link monitor units 215-1-215-4 further rewrite corresponding information that is stored in link aggregation table 212. The method of rewriting is described more concretely hereinbelow. Although a case is shown by way of example in FIG. 4 in which link monitor units 215-1-215-4 are provided in communication channels 600-5-600-8, respectively, only one link monitor unit may be provided that is used in common by communication channels 600-5-600-8.

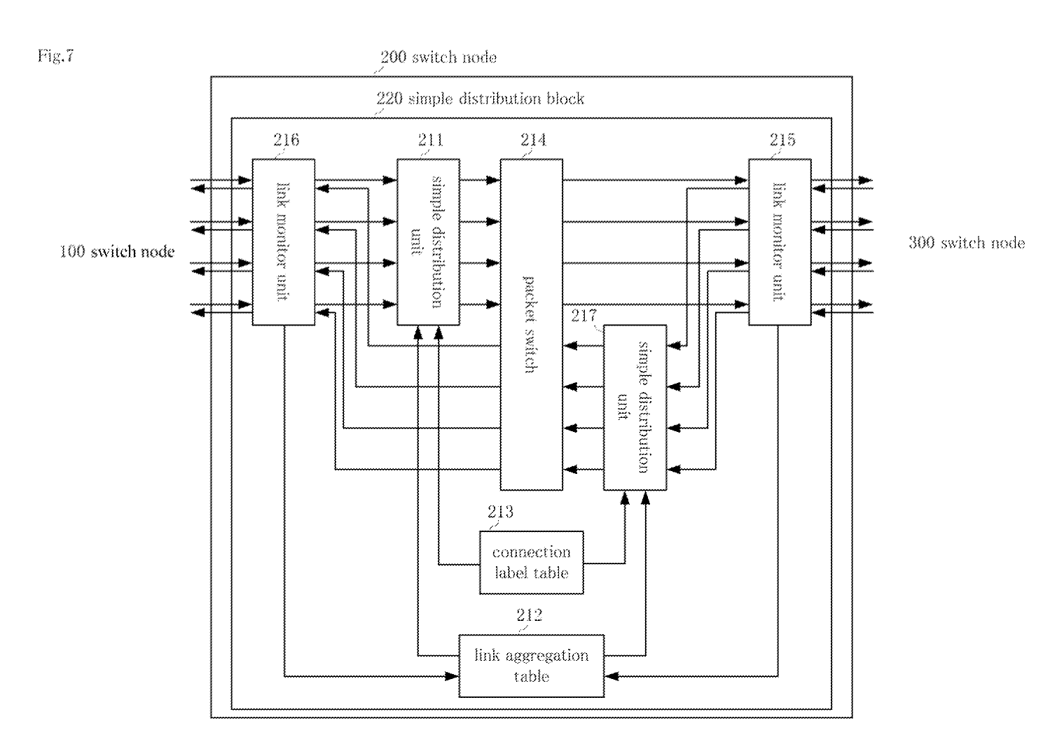

As shown in FIG. 7, in simple distribution block 220 of switch node 200 shown in FIG. 2, one link monitor unit 215 is provided in which link monitor units 215-1-215-4 shown in FIG. 4 have been unitized. Further, simple distribution unit 217 that subjects frame data that are transmitted from switch node 300 to switch node 100 to processing and link monitor unit 216 are provided in simple distribution block 220 in addition to simple distribution unit 211, link aggregation table 212, connection label table 213, and packet switch 214 that are shown in FIG. 4.

The function of simple distribution unit 217, which is to distribute frame data that are transmitted from switch node 300 to switch node 100, is the same as the function of simple distribution unit 211.

Link monitor unit 216 monitors whether a fault occurs in the communication channels with switch node 100. Link monitor unit 216 further rewrites corresponding information that is stored in link aggregation table 212 when the occurrence of a fault is detected in a communication channel with switch node 100.

A communication mode in which, of the constituent elements belonging to switch node 200 in FIG. 4 and FIG. 7, the FDB table management and the destination look-up function belonging to a switch node that is connected on a connection-oriented Ethernet are omitted and only the connection label table is specifically defined to determine the transmission destination of received frames. Because content of the mode relating to the transfer of these frames is well known to those skilled in the art as the above-described MPLS-TP or PBB-TE technology, and further, because content of the mode relating to the transfer of these frames is not directly related to the present invention, details regarding this construction are here omitted.

In addition, link monitor units 215-1-215-4 shown in FIG. 4 and link monitor units 215 and 216 shown in FIG. 7 are monitor means that monitor whether there is communication connection deterioration or a fault state on communication channels 600-1-600-8, which are connection-oriented logical data communication channels. These components have monitor functions relating to the function of monitoring various communication alarms such as WDM, SDH, and OTN devices to detect connection failures or to an ETHERNET-OAM and MPLS-OAM function of constantly communicating OAM frames on an Ethernet medium to monitor communication breaks. These functions are technology well known to those skilled in the art and, although these functions are a means of implementing the present invention, they are not directly related to the content of the invention, and detailed explanation is therefore here omitted.

The following explanation regards the actual processing when the above-described link monitor units 215-1-215-4 detect the occurrence of a problem.

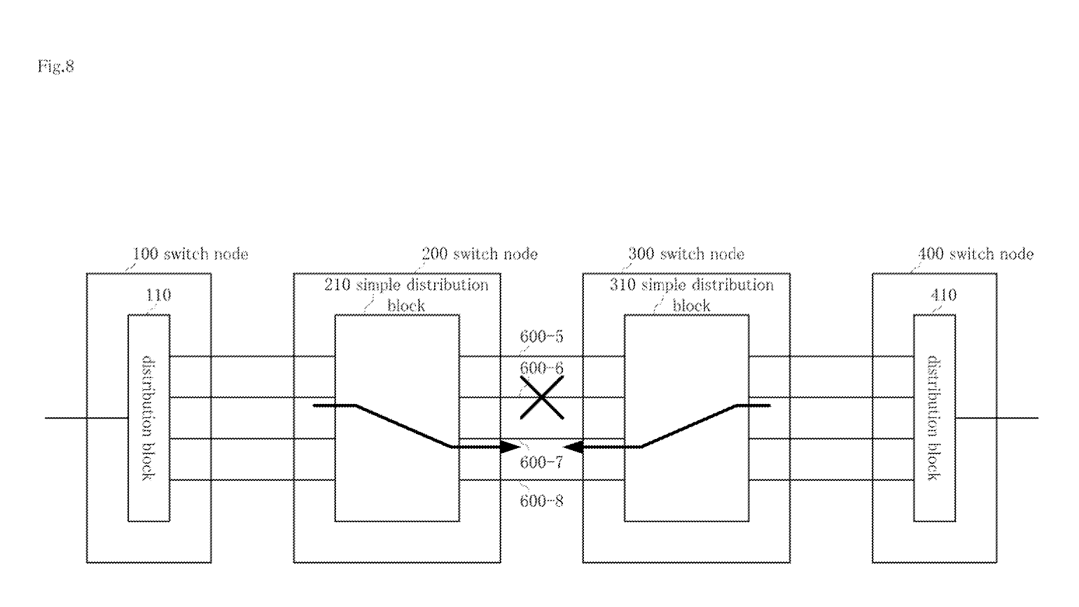

When a fault occurs on communication channel 600-6 (indicated by “x” in FIG. 8) as shown in FIG. 8, a process of distribution to another communication channel (in this case, communication channel 600-7), i.e., a detour operation, is carried out.

At this time, link monitor unit 215-2 that is monitoring communication channel 600-6 rewrites (alters) the correspondence that is stored by link aggregation table 212.

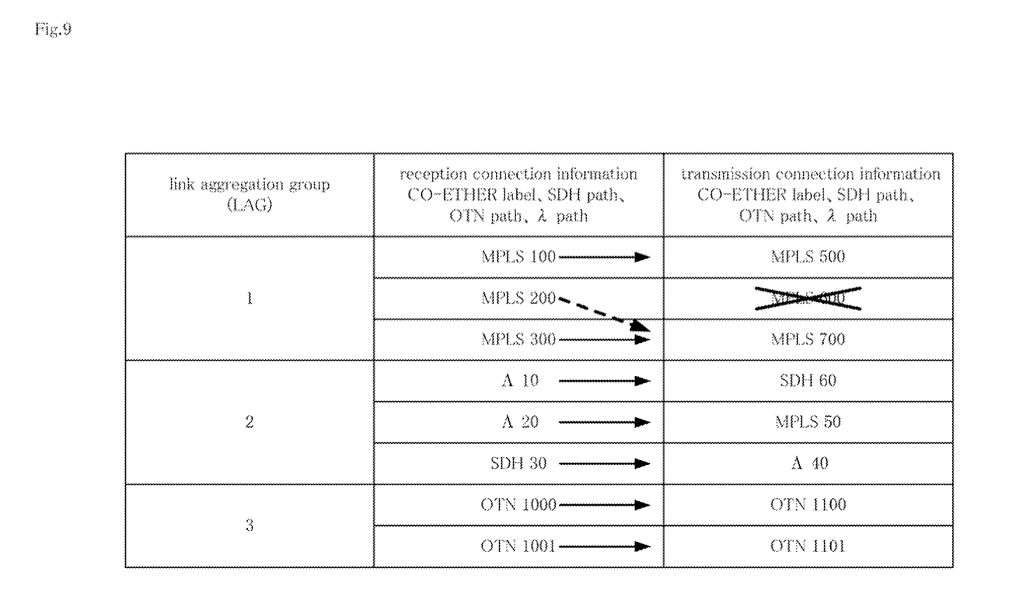

As shown in FIG. 9, when link monitor unit 215-2 detects that a fault has occurred in communication channel 600-6, the correspondence that is stored in link aggregation table 212 is rewritten such that frame data are not transmitted to the communication link on which the fault occurred (in this case MPLS600). At this time, link monitor unit 215-2 rewrites, of the transmission connection information that is stored in link aggregation table 212, transmission connection information for transmitting frame data to the communication link on which the fault occurred to transmission connection information of a communication link on which a fault has not occurred (in this case, MPLS700), whereby the fault detour operation is carried out.

This operation also enables easy switching of an operation that is implemented by again carrying out distribution (effecting redistribution) that uses a MAC address or IP address in an existing link aggregation function.

When the occurrence of a fault on a communication channel is detected, information indicating that the fault has occurred may be reported to another switch node.

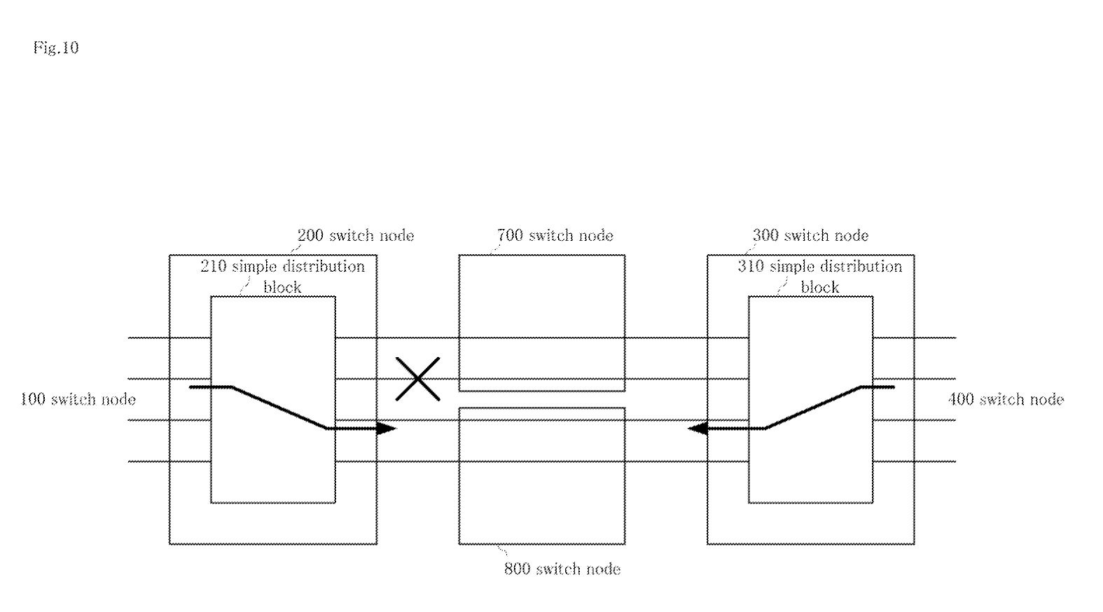

As shown in FIG. 10, a form is shown by way of example in which switch node 700 and switch node 800 are connected between switch node 200 and switch node 300. When it is detected in switch node 700 that a fault has occurred in the portion of the communication channel between switch node 200 and switch node 700, switch node 700 that has detected the fault also implements an alarm transfer operation to report to switch node 300 fault occurrence information indicating that a fault has occurred and the communication fault state. Together with these operations, switch control of link aggregation can be implemented in both of switch node 200 and switch node 300 and in switching operations defined for detouring around the faulty interval.

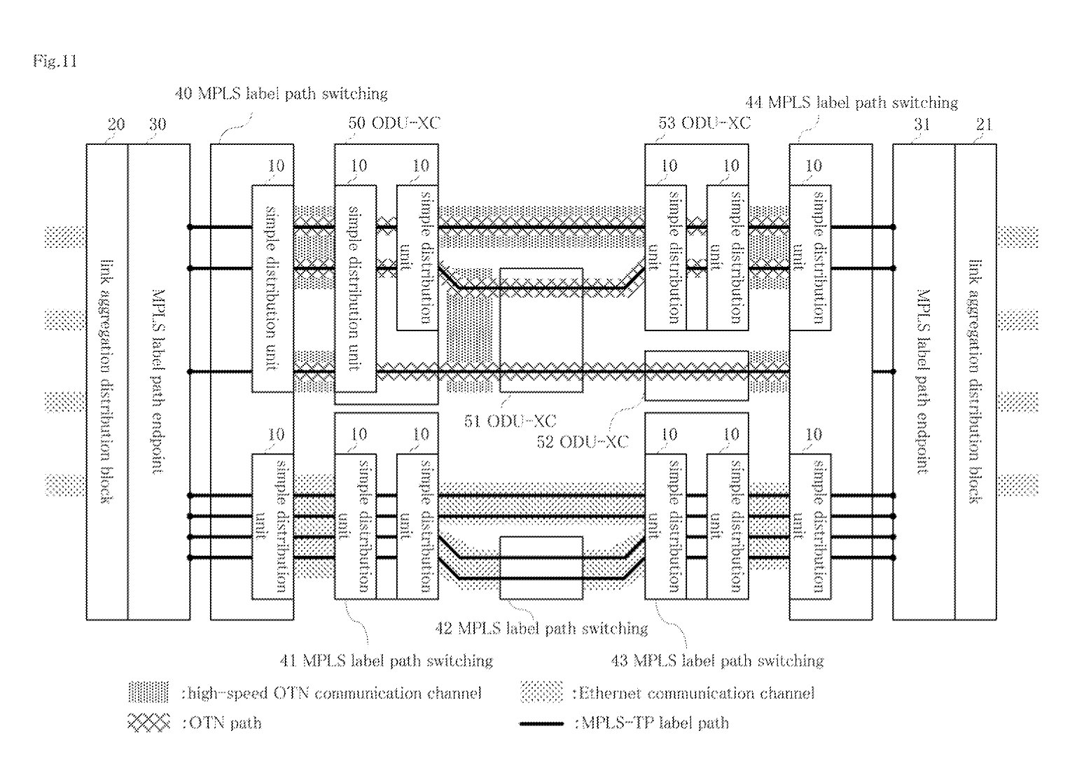

As shown in FIG. 11, the above-described simple distribution can be realized by simple distribution units 10 that are provided in ODU (Optical Channel Data Units)-XC (cross-connects) 50-53 and MPLS label path switching 40-44 that are relay nodes connected by way of high-speed OTN communication channels, OTN paths, Ethernet communication channels, MPLS-TP label paths between link aggregation distribution blocks 20 and 21 that are the communication network edges and MPLS label path endpoints 30 and 31.

The above-described communication system is applied to a CO (Connection-Oriented)-ETHERNET communication mode or cross-connect switching mode.

Transfer of link aggregation and switching at the time of a fault can thus be easily implemented in a connection-oriented switch node apparatus.

This is possible because, instead of a “distribution mode” that uses existing MAC addresses or IP addresses, the transfer and switching of link aggregation is implemented by defining and switching the connected state between reception connections and transmission connections.

In addition, it is possible to define various physical or logical communication connections in connections, and further, to construct link aggregation that does not depend on the media.

These capabilities result from the introduction of the concept of “connection” that is not a distribution method that uses only existing MAC addresses or IP addresses, whereby any type of like connections can be simply handled as link aggregation.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A communication system that is made up from a plurality of switch nodes that distribute and transmit received frame data to desired destinations and that uses link aggregation to carry out frame data communication among the plurality of switch nodes, wherein a relay node among said plurality of switch nodes comprises:
a link aggregation table that stores reception connection information for identifying connections of said received frame data in association with transmission connection information for identifying connections to which said frame data are to be transmitted; and
a simple distribution unit that, when said frame data are received, searches said link aggregation table for transmission connection information that is placed in association with the reception connection information of said frame data that was received and that distributes and transmits said frame data to the connection of the transmission connection information that was found.

2. The communication system as set forth in claim 1, wherein said relay node comprises:
a link monitor unit that monitors a communication link that is a communication channel between that relay node and another switch node that is connected to the relay node and that, upon detecting the occurrence of a fault on the communication link, rewrites the correspondence that was stored in said link aggregation table such that said frame data are not transmitted to the communication link in which the fault occurred.

3. The communication system as set forth in claim 2, wherein said link monitor unit rewrites, of the transmission connection information that is stored in said link aggregation table, transmission connection information for transmitting said frame data to said communication link in which a fault has occurred to transmission connection information of a communication link in which a fault has not occurred.

4. The communication system as set forth in claim 1, wherein:
said link aggregation table stores link aggregation group identification information for identifying link aggregation groups, said reception connection information, and said transmission connection information in association with each other; and said simple distribution unit, upon receiving said frame data, searches said link aggregation table for transmission connection information that is placed in association with the reception connection information and link aggregation group identification information of the link aggregation group being used by the received frame data and that distributes and transmits said frame data to the connection of the transmission connection information that was found.

5. The communication system as set forth in claim 1, wherein said relay node includes:
a plurality of reception ports that receive said frame data;
a plurality of transmission ports that transmit said frame data; and
a connection label table that stores said reception connection information, said transmission connection information, reception port numbers for identifying the reception port that received said frame data, and transmission port numbers for identifying the transmission port that is to transmit said frame data in association with each other;
wherein said simple distribution unit, upon receiving said frame data, searches said connection label table for the transmission port number and transmission connection information that are placed in association with the reception connection information and the reception port number that received the frame data, and that distributes and transmits said frame data to the transmission port of the transmission port number and the connection of the transmission connection information that were found.

6. The communication system as set forth in claim 1, wherein said communication system is applied to a CO-ETHERNET communication mode.

7. The communication system as set forth in claim 1, wherein said communication system is applied to a cross-connect switching mode.
